(19) United States
(12) Patent Application Publication
(10) Pub. No.: US 2005/0098692 A1
(43) Pub. Date: May 12, 2005

(54) Portable device support structure

(76) Inventor: Wen-Chang Yang, San-Chung City (TW)

Correspondence Address: Douglas M. Eveleigh;Mayer, Brown, Rowe & Maw LLP, P.O. Box 2828, Chicago, IL, 60690-2828, US

(21) Appl. No.: 10/786,666

(22) Filed: Feb. 25, 2004

(30) Foreign Application Priority Data
Apr. 15, 2003 (CN) 03225131.9

(51) Int. Cl. F16M 11/00

(52) U.S. Cl. 248/163.1

(57) ABSTRACT

One embodiment of the invention comprises a portable device support structure having a support section including a plurality of support legs, a clamping section connected to the support section, the clamping section having a first section and a second section, wherein at least the first section is movable. The portable device support structure also includes an adjusting member which adjusts the position of the first section with respect to the second section. The clamping section clamps the portable device when the portable device is placed between the first section and the second section and when the adjusting member is actuated to apply force on the portable device between the first section and the second section.

### FIELD OF INVENTION

This invention relates generally to structures used to support portable consumer devices, and more particularly to support structures used for camera cellular phones.

### BACKGROUND OF INVENTION

Portable cellular phones have in the recent years become more compact in size, while adding functionality. For instance, it is now typical that portable cellular phones will include the functionality of a web browser, game console, and/or the functionality of an email sending and receiving device. Recently, cellular phone manufacturers have begun to incorporate digital cameras in their phones, which are sometimes called “picture phones”. These digital cameras allow a user to take pictures and send them to other users of camera phones as well as to email recipients as attachments. Most of the time, the camera function within the cellular phone will include a self timer for shutter release, so that the camera user can attempt to include himself or herself in a picture. The problems encountered with camera cellular phones and their self-timers, however, is that it is difficult to place the cellular phone in a desired orientation so that the lens will be pointing to the desired picture area without a person holding the camera cellular phone. This is because camera cellular phones, due to their compact size, do not include a standard threaded insert for connecting to a tripod (as do most other types of cameras), and do not come with any means of mounting and steadying the camera cellular phone for a self timing function. As a result, the self timing function on camera cellular phones is seldomly used by camera cellular phone users. Moreover, the lack of a tripod mount or means of steadying a camera cellular phone can lead to blurry photos, even when the self-timing function is not desired. Accordingly, there is a need for a device that can hold and steady a camera cellular phone for purposes of, for example, a self-timed shutter release. These and other needs will become more apparent upon a review of the specification, drawings and claims, set forth below.

### SUMMARY OF THE INVENTION

One embodiment of the invention comprises a portable device support structure having a support section including a plurality of support legs, a clamping section connected to the support section, the clamping section having a first section and a second section, wherein at least the first section is movable. The portable device support structure also includes an adjusting member which adjusts the position of the first section with respect to the second section. The clamping section clamps the portable device when the portable device is placed between the first section and the second section and when the adjusting member is actuated to apply force on the portable device between the first section and the second section.

### BRIEF DESCRIPTION OF THE DRAWINGS

FIG. 1 is a front perspective view of one embodiment of the present invention;

FIG. 2 is an assembly view of a connecting member of one embodiment of the present invention;

FIG. 3 is a front perspective view of a support leg of one embodiment of the present invention;

FIG. 4 is a front view of the support leg shown in FIG. 3;

FIG. 5 is a right side view of the support leg shown in FIG. 3;

FIG. 6 is a rear view of a support section of one embodiment of the present invention;

FIG. 7 is a left side view of the support section of FIG. 6;

FIG. 8 is a rear perspective view of the support section of FIG. 6;

FIG. 9 is an assembly view of a clamping section of one embodiment of the present invention;

FIG. 9A is an assembly view of a clamping section of one embodiment of the present invention with a gripping insert thereon removed;

FIG. 10 is front perspective view of one embodiment of the present invention with a pivotably mounted extension piece in a folded position;

FIG. 11 is a front perspective view of one embodiment of the present invention with two pivotably mounted extension pieces in a folded position;

FIG. 12 shows a method of using one embodiment of the present invention;

FIG. 13 shows a method of using one embodiment of the present invention;

FIG. 14 shows a method of using one embodiment of the present invention;

FIG. 15 shows a method of using one embodiment of the present invention;

FIG. 16 shows a method of using one embodiment of the present invention; and

FIG. 17 shows a method of using one embodiment of the present invention.

### DETAILED DESCRIPTION OF THE PREFERRED EMBODIMENT

While the present invention is capable of embodiment in various forms, there is shown in the drawings and will be hereinafter described a presently preferred embodiment with the understanding that the present disclosure is to be considered as an exemplification of the invention, and is not intended to limit the invention to the specific embodiment illustrated.

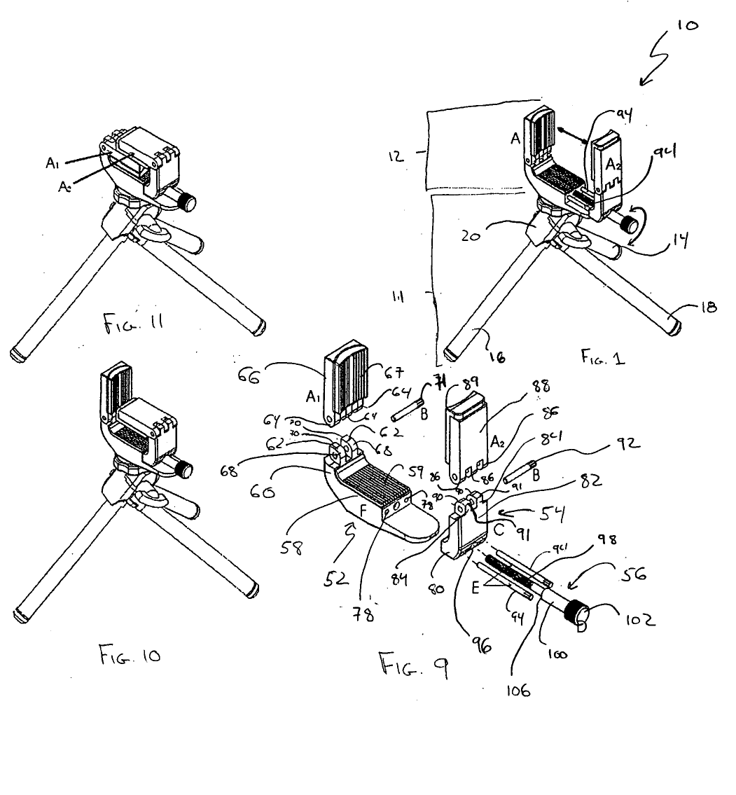

With reference to FIG. 1, there is shown a portable device support structure 10 in accordance with one embodiment of the present invention. The portable device support structure comprises two main sections. The first is a support section 11 and the second is a clamping section 12. The support section 11 comprises three support legs 14, 16 and 18, forming a tripod support configuration. It will be appreciated, however, that more or less support legs can be used in the practice of the present invention and that the present invention is not limited to a support system using three support legs. In one embodiment of the present invention, the support legs 14, 16 and 18 include telescoping members 19 (FIG. 15), which add height to the portable device support structure and also add stability when extended.

Support leg 16 is preferably fixedly attached to connecting member 20, which is formed of two halves, 21A and 21B (FIG. 2) and it is preferred that support legs 14 and 18 are pivotably connected to both connecting member 20 and to shaft 22 so that support legs 14 and 18 can pivot along two axes, which in the preferred embodiment are the X and Z axes. In a preferred embodiment, support legs 14 and 18 are connected via shaft 22, which passes through aperture 24 (formed by halves 21A and 21B of connecting member 20), so that they will pivot along the X axis in unison. However, it will be appreciated that support legs 14 and 18 can also pivot independently. It will also be appreciated that aperture 24 is sized slightly larger than the diameter of shaft 22 so that shaft 22 can rotate within aperture 24. The fit between shaft 22 and aperture 24, however, maintains a tight fit between aperture 24 and shaft 22, thereby preventing the shaft 22 from moving in a direction perpendicular to the longitudinal axis of the shaft 22.

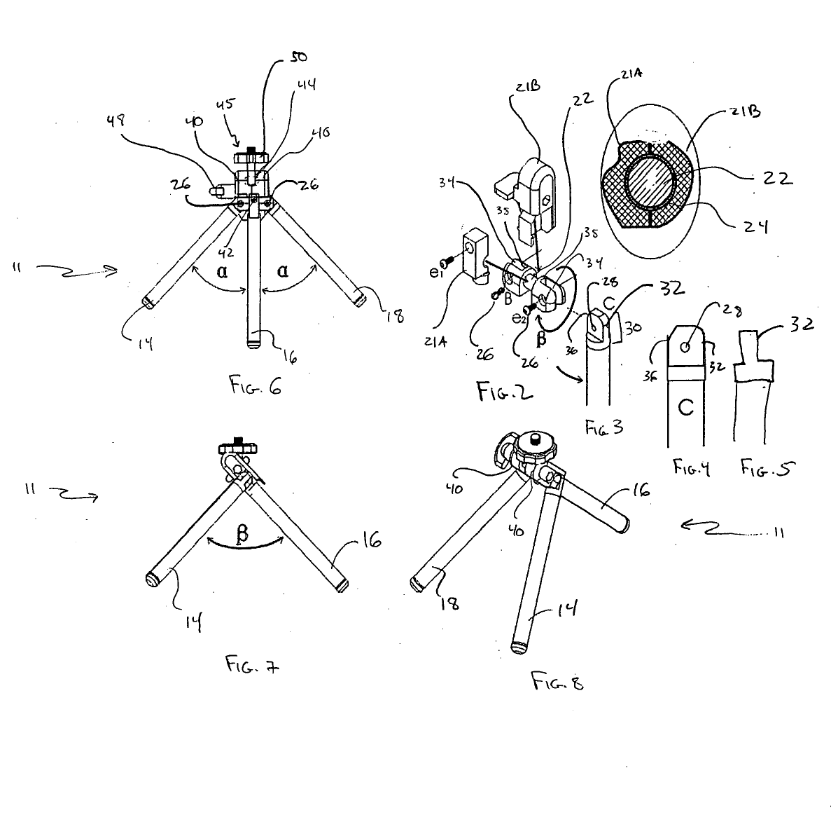

In order to allow support legs 14 and 18 to pivot along the Z axis, legs 14 and 18 pivot about screws 26, which pass through apertures 28 at the top section 30 of legs 14 and 18. Top section 30 preferably comprises an inverted T-shaped projection 32, when viewed from the side, as seen in FIGS. 3 and 5, and an inverted U-shaped projection 32 when viewed from the front, as seen in FIG. 4. A portion of the projections 32 fit within grooves 34 in connecting member 20. When viewed from the front, projections 32 have keyed sections 36, which act as rotational stops to prevent the legs 14 and 18 from swinging too far away from the center support leg 16. Keyed section are preferably at an approximately 45 degree angle from vertical. As can be appreciated, as the legs 14 and 18 are swung out from the center support leg 16, keyed sections 36 will contact vertical walls 38 of grooves 34 to prevent further rotational movement. Also, it is preferred that when legs 14 and 18 are pivoted outward along the Z axis, an approximately 45 degree angle is formed between each of the legs 14 and 18 and leg 16, as shown in FIG. 6. Also, it is preferred that when the legs 14 and 18 are pivoted on shaft 22 along the X axis, an approximately 90 degree angle is formed between each of the legs 14 and 18 and leg 16, as shown in FIG. 7. As those with skill in the art will appreciate, however, other angles can be used with the present invention.

As best seen in FIG. 6, connecting member 20 is connected to split keepers 40 via screw 42. Split keepers act as a ball socket for ball 44, which is attached to a threaded portion 45. Split keepers can be brought closer together by adjusting screw 48, thus locking ball 44 in a particular orientation. Platform 50 is attached to threaded portion 45, and allows a user to turn the threaded portion 45 (and the connected ball 44) to thread the threaded portion into clamping section 12 and also provides a surface upon which the clamping section 12 can rest. As those with skill in the art will appreciate, the ball and socket configuration formed by split keepers 40 and ball 44 allows the threaded portion 45 to be pivotably mounted to connecting member 20 thereby providing a multitude of orientations in which the clamping section 12 can be placed.

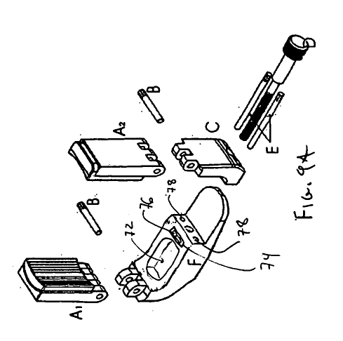

As shown in FIG. 9, clamping section 12 comprises three main components: a static section 52, a movable section 54 and a screw 56. Static section 52 contains a horizontal portion 58 and a vertical portion 60. Vertical portion 60 contains projections 62 at the end thereof, which are designed to mesh with projections 64 of a pivotably mounted extension piece 66. When viewed from the front, the projections 62 contain rounded portions 68 on the right side thereof and squared off portions 70 on the left side thereof. As will be appreciated, squared off portions 70 prevent the pivotably mounted extension piece from rotating past the 90 degree point from horizontal portion 58, while the rounded portions allow the pivotably mounted extension piece 66 to fold and rotate towards the horizontal portion 58. Shaft 71 acts to join the pivotably mounted extension piece 66 with the vertical portion 60 and to provide a pivot point between the pivotably mounted extension piece 66 and vertical portion 60. The horizontal section 58 and the pivotably mounted extension piece 66 preferably contain gripping inserts 59 and 67, respectively, that act to protect a device, such as a camera cellular phone, from scratches, while having a sufficiently high coefficient of friction to reduce the chance of slippage when the clamping section is clamping a portable device, such as a camera cellular phone. In a preferred embodiment the gripping inserts 59 and 67 are made out of rubber. The static section also contains threaded insert 61 on the bottom side of the horizontal portion 58 (see FIG. 12), which is designed to mate with threaded portion 45. The horizontal portion 58 also includes a bowl section 72 and a recess 74 underneath the gripping insert 59, as shown in FIG. 9A. Recess 74 is designed to accommodate and hold a nut 76, which mates with screw 56. Bowl section 72 allows the screw 56 to move in and out of the static section 52 without interference from any structural members of the static section 52. The horizontal section also contains guide bores 78, which are used to help guide and maintain the orientation of movable section 54.

As shown in FIG. 9, movable section 54 comprises a horizontal portion 80 and a vertical portion 82. Vertical portion 82 contains projections 84 at the end thereof, which are designed to mesh with projections 86 of a pivotably mounted extension piece 88. As with pivotably mounted extension piece 66 and horizontal portion 58, pivotably mounted extension piece 88 includes a gripping insert 89. When viewed from the front, the projections 86 contain rounded portions 90 on the left side thereof and squared off portions 91 on the right side thereof. As will be appreciated, squared off portions 91 prevent the pivotably mounted extension piece from rotating past the 90 degree point from horizontal portion 80, while the rounded portions 90 allow the pivotably mounted extension piece to fold and rotate towards the horizontal portion 80. Shaft 92 acts to join the pivotably mounted extension piece 88 with the vertical portion 82 and to provide a pivot point between the pivotably mounted extension piece 88 and vertical portion 82.

Horizontal portion 80 has projecting therefrom two rods 94 (see FIG. 1) which fit within guide bores 78 of static section 52 to maintain the orientation of movable section 54. Also, horizontal portion 80 contains a countersunk bore 96 which accepts screw 56. As can be seen by reference to FIGS. 1 and 9-11, the vertical portion 60 of the static section 52 is lower in height than the vertical portion 82 of the movable section 54. This allows pivotably mounted extension piece 66 to fold below the height of vertical portion 82 and allows pivotably mounted extension piece 88 to fold onto the top of pivotably mounted extension piece 66, thereby allowing a user to make more compact the portable device support structure of one embodiment of the present invention for easier transport in a pocket, purse, etc. It will be appreciated, however, that the invention need not contain pivotably mounted extension pieces, and instead can contain vertical portions without any pivoting members whatsoever.

As shown in FIG. 9, screw 56 preferably contains three sections. A threaded section 98, a non-threaded section 100 which is larger in diameter than the threaded section, and a user adjusting portion 102 that facilitates a user rotating the screw 56, when desired. In the preferred embodiment, the user adjusting portion 102 comprises a knurled surface at one end of the screw 56. However, it will be appreciated that user adjusting portion 102 can comprise any structure used for turning a threaded device, such as flat head, phillip head, allen key, and torx structures, etc. The vertical edge 106 between the threaded section 98 and non-threaded section 100 acts to push the movable portion 54 when the screw 56 is turned in a clockwise position.

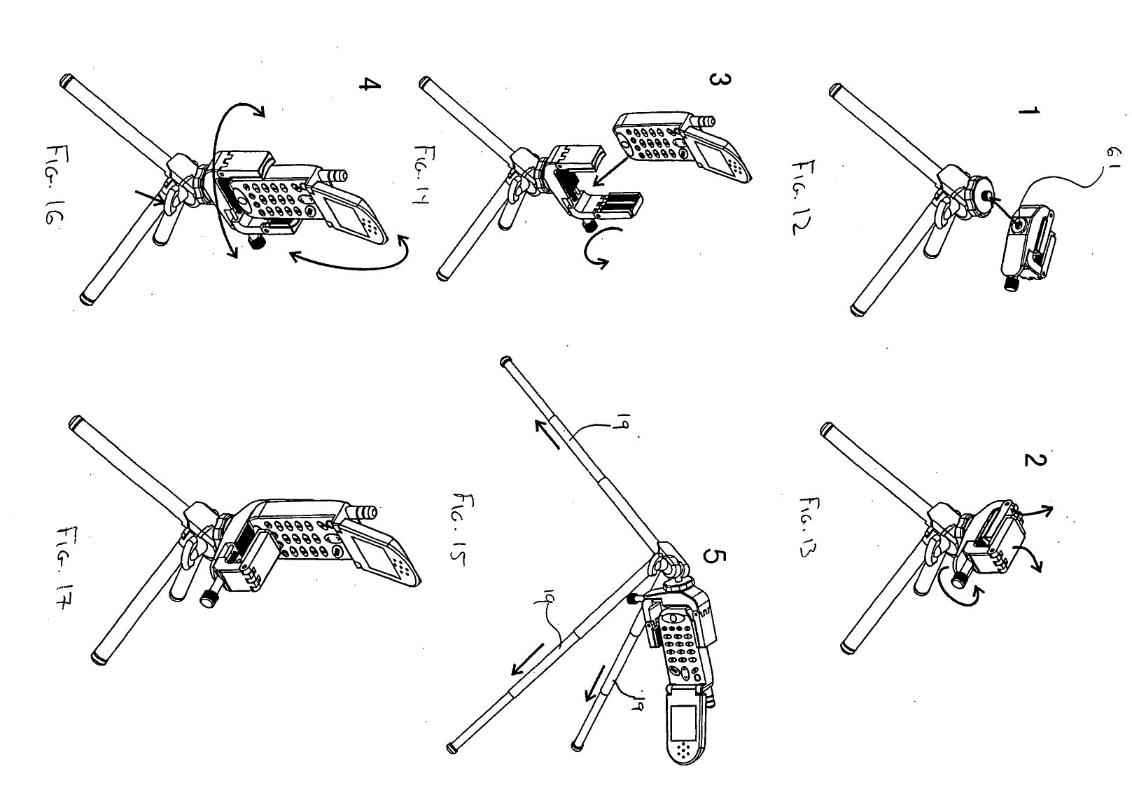

The operation of one embodiment of the present invention will now be described with reference to FIGS. 12-17. When the portable device support structure is not in use, and in order for a user to have the portable device support structure in a compacted state, the support members 14, 16 and 18 will be positioned so that they all lie within a single plane and the pivotably mounted extension pieces will be folded down. Also, the clamping section 12 may be detached from support section 11. When a user desires to use the portable device support structure he or she will, accordingly, screw the clamping section 12 into the support section 11 and then rotate support members 14 and 18 forward and then outward to form a tripod base (FIG. 12). Next, the user will unfold the pivotably mounted extension pieces to a vertical position and will place the camera cellular phone, or other portable device in the clamping section so that the camera lens will be pointing in an outward direction and not be blocked by any structure of the portable device support structure assembly (FIGS. 13 & 14). In order to secure the camera cellular phone, screw 56 is rotated clockwise until movable section 54 applies sufficient force on the camera cellular phone, between the movable section 54 and the static section 52, to prevent the camera cellular phone from becoming separated from clamping section 12 (FIG. 14). If desired, telescoping members 19 can be extended to provide additional height and stability of the tripod (FIG. 15). Once the camera cellular phone is secured to the clamping section 12, the clamping section can be pivoted using the ball 44 and the ball socket formed by split keepers 40 to achieve a desired orientation. Once a desired orientation is attained, this orientation can be locked in place using locking screw 58 (FIG. 16). In an alternate method of use, the pivotably mounted extension piece 88 of movable section 54 can be left folded when the camera cellular phone is placed in clamping section 12. In this method of use the top of pivotably mounted extension piece 88 is responsible for transmitting the force of the movable portion 54 to the camera cellular phone.

The foregoing description of a preferred embodiment of the invention has been presented for purposes of illustration and description, and is not intended to be exhaustive or to limit the invention to the precise form disclosed. For example, although one embodiment of the present invention is preferably used in conjunction with a camera cellular phone, the invention is not limited to use with camera cellular phones and can be used with any other portable device. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined by the claims set forth below.

1. A portable device support structure comprising:
a support section comprising a plurality of support legs;
a clamping section connected to said support section, said clamping section comprising a first section and a second section, wherein at least said first section is movable;
an adjusting member which adjusts the position of the first section with respect to the second section;
wherein said clamping section clamps said portable device when the portable device is placed between said first section and said second section and when said adjusting member is actuated to apply force on said portable device between said first section and said second section.

2. The support structure of claim 1, wherein said support section comprises three support legs.

3. The support structure of claim 1, wherein said portable device is a camera cellular phone.

4. The support structure of claim 1, wherein said adjusting member is a screw that runs through said first section and is connected to a threaded member in said second section.

5. The support structure of claim 1, wherein said first section includes a pivotably mounted extension piece.

6. The support structure of claim 1, wherein said second section includes a pivotably mounted extension piece.

7. The support structure of claim 1, wherein said first section and said second section include a pivotably mounted extension piece.

8. The support structure of claim 7, wherein the lengths of said pivotably mounted extension pieces on said first section and said second section are different.

9. The support structure of 1, wherein said support legs include telescoping members.

10. The support structure of claim 1, wherein said clamping section is pivotably mounted to said support section.

11. A camera cellular phone tripod comprising:
a support section comprising three support legs;
a clamping section connected to said support section, said clamping section comprising a first section and a second section, wherein at least said first section is movable;
an adjusting member which adjusts the position of the first section with respect to the second section;
wherein said clamping section clamps said camera cellular phone when the camera cellular phone is placed between said first section and said second section and when said adjusting member is actuated to apply force on said camera cellular phone between said first section and said second section.

12. The support structure of claim 11, wherein said adjusting member is a screw that runs through said first section and is connected to a threaded member in said second section.

13. The support structure of claim 11, wherein said first section includes a pivotably mounted extension piece.

14. The support structure of claim 11, wherein said first section and said second section include a pivotably mounted extension piece.

15. The support structure of claim 14, wherein the lengths of said pivotably mounted extension pieces on said first section and said second section are different.

16. The support structure of 11, wherein said support legs include telescoping members.

17. The support structure of claim 11, wherein said clamping section is pivotably mounted to said support section.

18. A camera cellular phone tripod comprising:
a support section comprising three telescoping support legs;
a clamping section connected to said support section, said clamping section comprising a first section and a second section, wherein at least said first section is movable;
a first pivotably mounted extension piece connected to said first section;
a second pivotably mounted extension piece connected to said second section;
an adjusting member which adjusts the position of the first section with respect to the second section;
wherein said clamping section clamps said camera cellular phone when the camera cellular phone is placed between said first section and said second section and when said adjusting member is actuated to apply force on said camera cellular phone between said first section and said second section.
